(19) United States
(12) Patent Application Publication
(10) Pub. No.: US 2010/0103319 A1
(43) Pub. Date: Apr. 29, 2010

(54) ON-SCREEN DISPLAY CIRCUIT AND METHOD FOR CONTROLLING THE SAME

(75) Inventors: Chun Hao Li, Miaoli County (TW); Wen Chin Wang, Tainan City (TW); Pin Shan Wu, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: MYSON CENTURY, INC., Hsinchu (TW)

(21) Appl. No.: 12/504,261

(22) Filed: Jul. 16, 2009

(30) Foreign Application Priority Data
Oct. 29, 2008 (TW) 097141532

(51) Int. Cl. H04N 5/50

(52) U.S. Cl. 348/569; 348/E05.097

(57) ABSTRACT

An on-screen display (OSD) circuit comprises a microprocessor, a serial peripheral interface (SPI) controller, an upload controller and an OSD controller. The SPI controller is connected to the microprocessor for receiving data of an external flash memory. The upload controller is configured to control data access between the SPI controller and the memory. The OSD controller is configured to control a display of an operating screen by the data stored in the memory. The upload controller stores a font table or an icon table and background screen data in the memory while the OSD controller is active.

### BACKGROUND OF THE INVENTION

1. Field of the Invention

The present invention relates to an on-screen display (OSD) circuit and the control method thereof, and more particularly, to an OSD circuit which can directly refresh display frames and the control method thereof.

2. Description of the Related Art

An on-screen display is an apparatus for adjusting parameters of a monitor. It uses an operating screen overlapping the display screen to let users make adjustments thereon. FIG. 1 shows a conventional OSD circuit. The OSD circuit 100 includes a microprocessor 102, a ROM 104 and an OSD controller 106. The microprocessor 102 controls the operation of the OSD 106. The ROM 104 is used to store data for operating the screen, such as a font table and an icon table. The OSD controller 106 displays an operation menu on the screen by reading the data stored in the ROM 104. However, because the capacity of the ROM 104 limits the types of languages and fonts that can be displayed, the operation menu is quite basic in appearance and function. In addition, the data stored in the ROM 104 is determined during manufacturing, and therefore it is inconvenient for users because the displayed data cannot be changed.

FIG. 2 shows another conventional OSD circuit. The OSD circuit 200 includes a microprocessor 202, a static random access memory (SRAM) 204, an OSD controller 206 and an embedded flash memory 208. The microprocessor 202 controls the OSD controller 206 and data access to and from the embedded flash memory 208 and SRAM 204. The embedded flash memory 208 is used to store the data of the operating screen, which is stored in the SRAM 204 from the microprocessor 202. The OSD controller 206 displays the operating screen by reading data stored in the SRAM 204. The embedded flash memory 208 allows the OSD circuit 200 to change the operating screen more easily. However, the embedded memory 208 has a high cost, and the limited capacity of the embedded memory 208 also limits applicable languages and font types.

FIG. 3 shows another conventional OSD circuit. The OSD circuit 300 is connected to an SPI flash memory 310, and includes a microprocessor 302, an SRAM 304, an OSD controller 306, and an SPI controller 308. The microprocessor 302 controls the OSD controller 306 and the SPI controller 308, and also manages the access to and from the SRAM 304. The flash memory 310 is used to store the data of the operating screen, which is moved from the microprocessor 302 to the SRAM 304. The OSD controller 306 displays the operating screen by reading the SRAM 304. However, with the growing trend of using icons in the operating screen, the amount of data used increases dramatically. Therefore, it is necessary to pause the operation of the OSD controller 306 during the update of the OSD circuit 300 to prevent the screen disturbance resulting from the data writing from the microprocessor 302 to the SRAM 304. In addition, since the updated data of the operating screen needs to be stored in the SRAM 304 when the OSD controller 306 pauses, the SRAM 304 requires a large capacity, thus increasing the cost.

In conclusion, there is a demand in the industry for an OSD circuit design which is capable of updating data while the OSD controller is still active.

### SUMMARY OF THE INVENTION

An on-screen display (OSD) circuit in accordance with one embodiment of the present invention comprises a microprocessor, a serial peripheral interface (SPI) controller, an upload controller and an OSD controller. The SPI controller is connected to the microprocessor for receiving data from an external flash memory. The upload controller is configured to control data access between the SPI controller and the memory. The OSD controller is configured to control the display of an operating screen by the data stored in the memory. The upload controller stores a font table or an icon table and background screen data in the memory while the OSD controller is active.

A method for controlling an OSD in accordance with one embodiment of the present invention comprises the steps of: storing data of an operating screen to a memory while an OSD controller is not active; enabling the OSD controller and displaying the operating screen in accordance with data stored in the memory; and updating a font table or an icon table and background screen data stored in the memory within a frame period during which the OSD controller is active.

### BRIEF DESCRIPTION OF THE DRAWINGS

The invention will be described according to the appended drawings in which:

FIG. 1 shows a conventional OSD circuit;

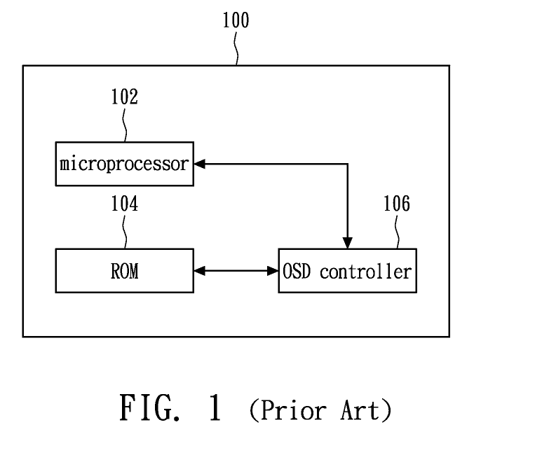

FIG. 2 shows another conventional OSD circuit;

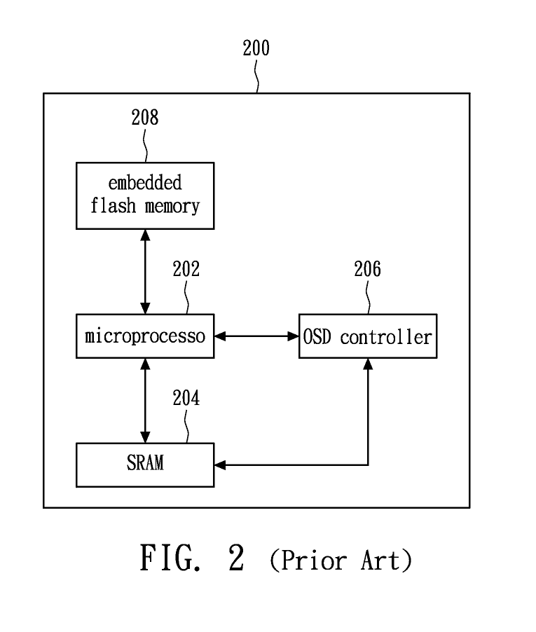

FIG. 3 shows another conventional OSD circuit;

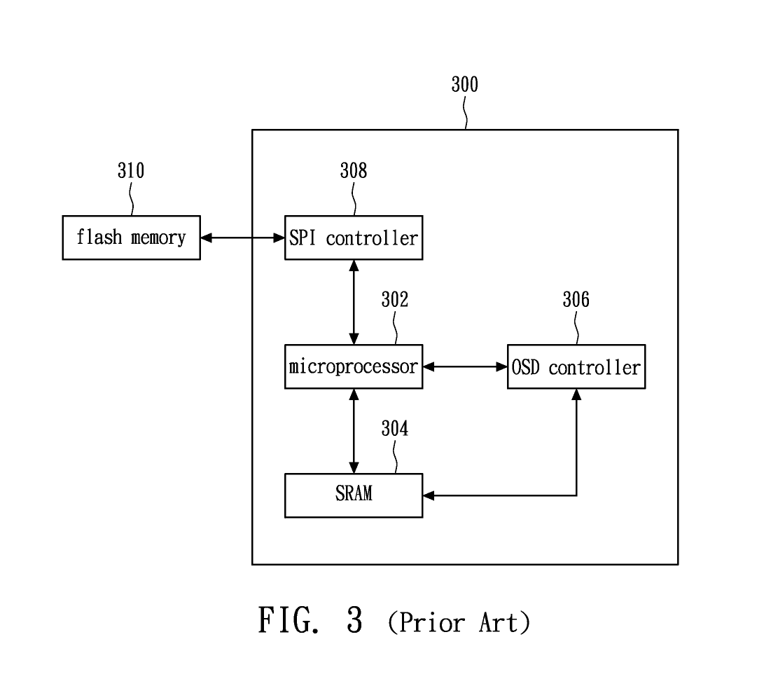

FIG. 4 shows an OSD circuit in accordance with one embodiment of the present invention;

FIG. 5 shows an OSD control flow in accordance with one embodiment of the present invention;

FIG. 6 shows a timing diagram of when the microprocessor stores data of the operating screen to the SRAM;

FIG. 7 shows another timing diagram of when the microprocessor stores data of the operating screen to the SRAM; and

FIG. 8 shows an SPI controller in accordance with one embodiment of the present invention.

### PREFERRED EMBODIMENT OF THE PRESENT INVENTION

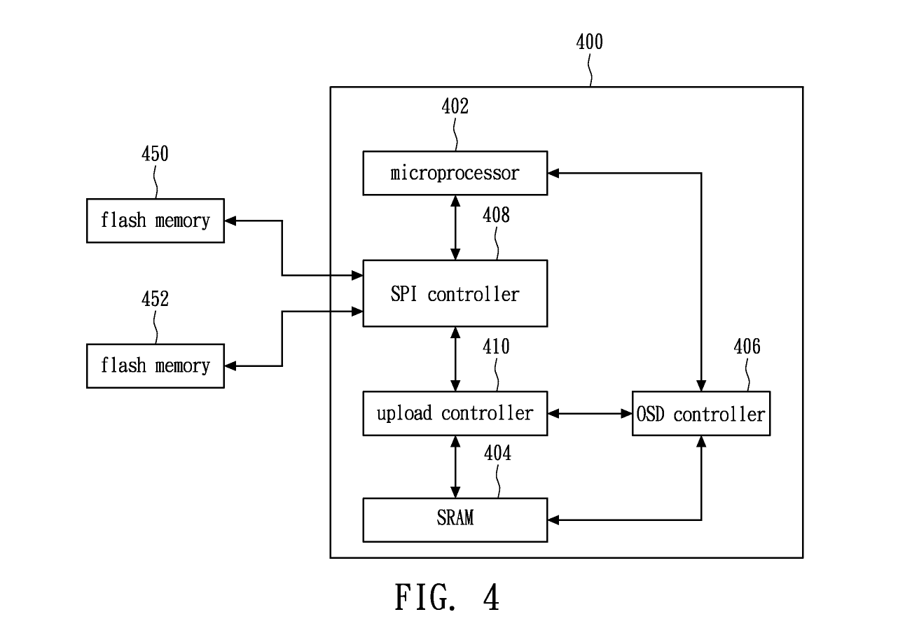

FIG. 4 shows an on-screen display (OSD) circuit in accordance with one embodiment of the present invention. The OSD circuit 400 includes a microprocessor 402, a static random access memory (SRAM) 404, an OSD controller 406, a serial peripheral interface (SPI) controller 408 and an upload controller 410. The OSD circuit 400 is connected to two SPI flash memories 450 and 452, which are used to store data of the operating screen. The SPI controller 408 is configured to receive and transmit data of the external flash memories 450 and 452. The upload controller 410 is used to control the operations between the SPI controller 408 and the SRAM 404. The OSD controller 406 displays the operating screen by reading data stored in the SRAM 404.

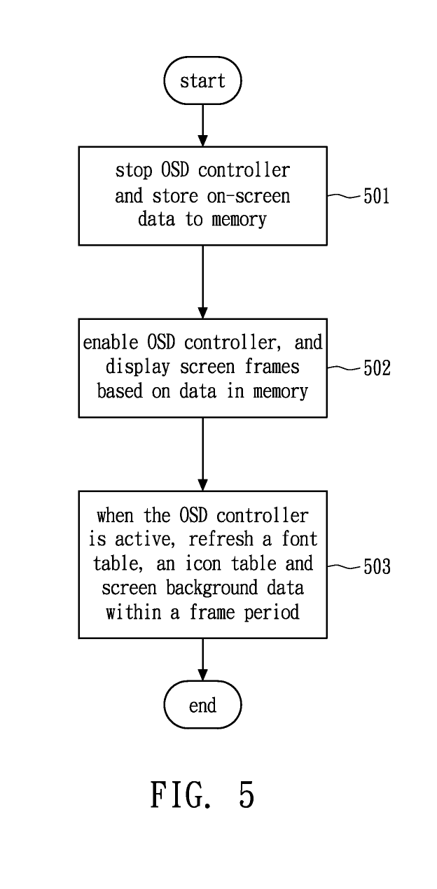

FIG. 5 shows an OSD control flow in accordance with one embodiment of the present invention. In step 501, the operation of an OSD controller is paused and data of the display frames are stored into a memory. In step 502, the OSD controller is enabled and the screen is displayed in accordance with the data stored in the memory. In step 503, the font table or icon table and background screen data stored in the memory are updated within a frame period during which the OSD controller is active.

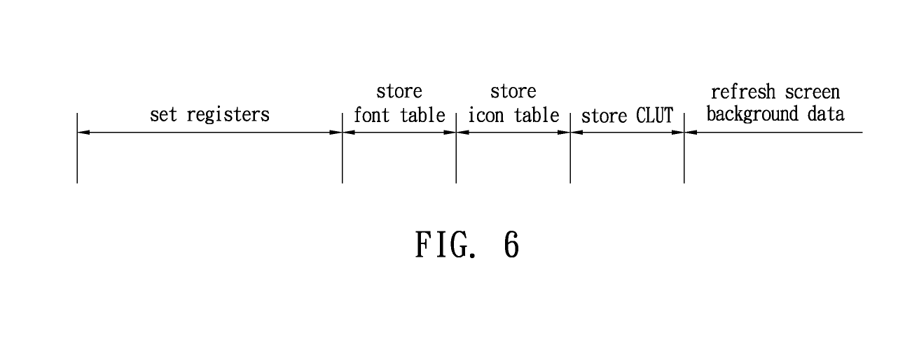

Referring to FIG. 4, while the OSD controller 406 is not yet active, the microprocessor 402 stores data of the operating screen to the SRAM 404, as mentioned in step 501, wherein the data includes a font table, an icon table and a color lookup table (CLUT). FIG. 6 shows a timing diagram of when the microprocessor 402 stores data of the operating screen to the SRAM 404. As shown in FIG. 6, the stored data includes parameter setting of the registers, font display table, font table, icon table, CLUT and background screen information, wherein the parameter setting of the registers, font display table, font table, icon table and CLUT are stored before the OSD controller 406 is active.

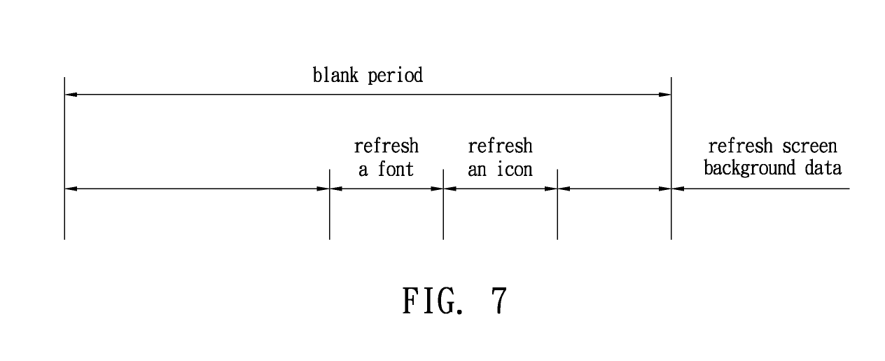

After the data is stored, the OSD controller 406 starts to operate, as mentioned in step 502. Meanwhile, if the operating screen needs to be updated, the upload controller 410 directly stores the updated data to the SRAM 404 without suspending the operation of the OSD controller 406. The upload controller 410 updates a font or an icon during the non-displaying period of the monitor, and updates the background screen data during the residual frame time, as mentioned in step 503 and shown in FIG. 7. Because of resistance of vision, a normal user will not notice any roughness in the operating screen display.

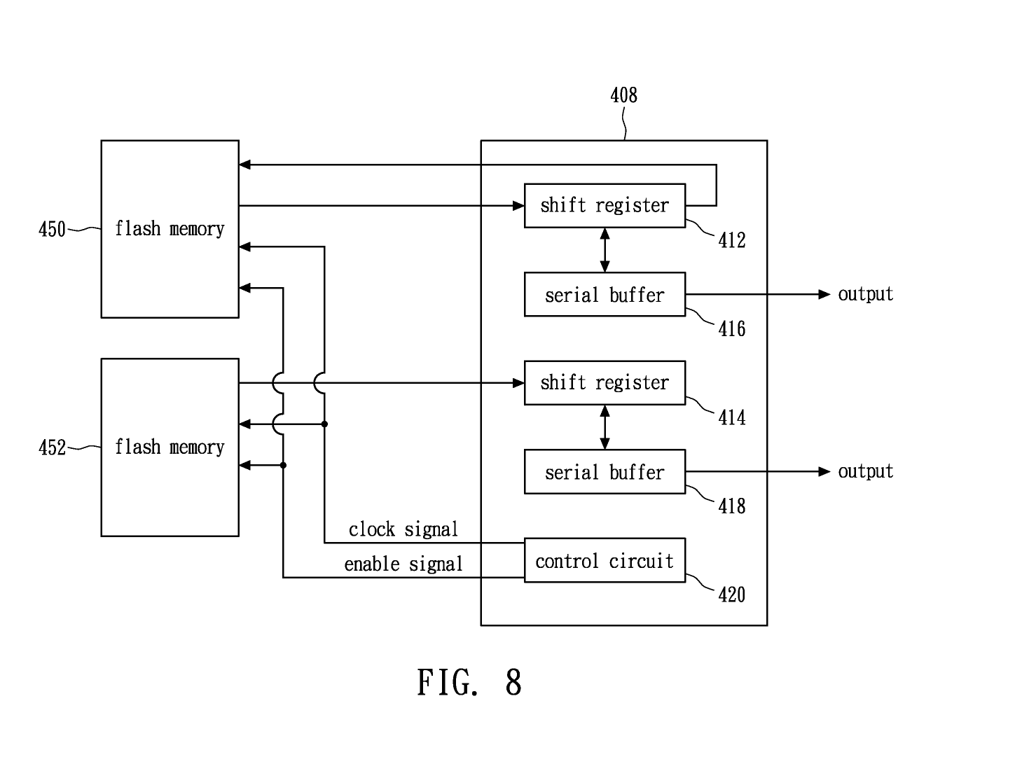

To accelerate the updating of the operating screen, the OSD circuit 400 is connected to two flash memories, and the SPI controller 408 can support the function of simultaneously reading two flash memories. FIG. 8 shows a block diagram of an SPI controller 408. The SPI controller 408 includes two shift registers 412 and 414, two serial buffers 416 and 418, and a control circuit 420. The two shift registers 412 and 414 are separately connected to the flash memories 450 and 452. The two serial buffers 416 and 418 are used to access the data of the two shift registers 412 and 414. The control circuit 420 is used to control the operations between the flash memories 450 and 452 and the other components of the SPI controller 408. As shown in FIG. 8, the SPI controller 408 supports the simultaneous functions of accessing the data in the flash memories 450 and 452 and at the same time outputting data to one of the flash memories 450 and 452. The quantity of the shift registers and serial buffers is not limited to two, and is flexible to expand to any number so as to connect more flash memories.

In conclusion, the OSD circuit 400 in accordance with one embodiment of the present invention directly updates the operating screen through the upload controller 410, thereby reducing the burden on the microprocessor 402. In addition, the upload controller 410 controls the speed at which the screen is updated, and therefore the display monitor is capable of performing display and updating simultaneously without causing any roughness for users. In another aspect, because the OSD circuit 400 supports the function of directly updating data, the SRAM 404 can be implemented with a small capacity memory.

The above-described embodiments of the present invention are intended to be illustrative only. Numerous alternative embodiments may be devised by persons skilled in the art without departing from the scope of the following claims.

What is claimed is:

1. An on-screen display (OSD) circuit, comprising:
a microprocessor;
a serial peripheral interface (SPI) controller connected to the microprocessor for receiving data of an external flash memory;
a memory;
an upload controller configured to control data access between the SPI controller and the memory; and
an OSD controller configured to control a display of an operating screen by the data stored in the memory;
wherein the upload controller stores a font table or an icon table and background screen data in the memory while the OSD controller is active.

2. The OSD circuit of claim 1, wherein the microprocessor stores display data in the memory while the OSD controller is not active.

3. The OSD circuit of claim 1, wherein the upload controller stores a font table or an icon table to the memory while the screen display is blank and the OSD controller is active.

4. The OSD circuit of claim 1, wherein the SPI controller is connected to a plurality of SPI flash memories.

5. The OSD circuit of claim 1, wherein the SPI controller comprises:
a plurality of shift registers connected to a plurality of SPI flash memories;
a plurality of serial buffers configured to store data in the plurality of the shift registers;
a control circuit configured to control operations between the flash memory and the plurality of shift registers;
wherein the quantity of the shift registers is equal to the quantity of the serial buffers.

6. The OSD circuit of claim 5, wherein the SPI controller simultaneously receives the data of the flash memories and outputs data to one of the flash memories.

7. The OSD circuit of claim 1, wherein the memory is a static random access memory (SRAM).

8. A method for controlling an on-screen display (OSD), comprising the steps of:
storing data of an operating screen to a memory while an OSD controller is not active;
enabling the OSD controller and displaying the screen in accordance with data stored in the memory; and
updating a font table or an icon table and background screen data stored in the memory within a frame period while the OSD controller is active.

9. The method of claim 8, wherein the data stored in the memory comprises a font table, an icon table and a color lookup table (CLUT) if the OSD controller is not active.

10. The method of claim 8, further comprising the step of updating a font or icon of the displayed data stored in the memory while the screen display is blank and the OSD controller is active.

11. The method of claim 8, wherein the storing step is performed by a processor while the OSD controller is not active.

12. The method of claim 8, wherein the updating step is performed by an upload controller while the OSD controller is active.

13. The method of claim 8, wherein the memory is a static random access memory (SRAM).
